(19) United States
(12) Patent Application Publication
(10) Pub. No.: US 2023/0153783 A1
(43) Pub. Date: May 18, 2023

(54) SYSTEM AND METHOD OF PLACING AN ORDER ON A DIGITAL PLATFORM

(71) Applicant: FLIPKART INTERNET PRIVATE LIMITED, Bengaluru (IN)

(72) Inventors: Snehith Paduchuri, Nallacheruvu (IN); Varun Chappidi, Hyderabad (IN); Pratik Agrawal, Bhatapara (IN)

(73) Assignee: FLIPKART INTERNET PRIVATE LIMITED, Bengaluru (IN)

(21) Appl. No.: 17/980,720

(22) Filed: Nov. 4, 2022

(30) Foreign Application Priority Data
Nov. 13, 2021 (IN) 202141052094

(51) Int. Cl. G06Q 20/22; G06Q 20/12; G06Q 20/08

(52) U.S. Cl. CPC G06Q 20/227; G06Q 20/12; G06Q 20/0855

(57) ABSTRACT

A system and method of placing an order on a digital platform. The method encompasses transmitting to a user device, a payable amount based on a created order. Further the method comprises receiving from the user device, a split pay request to pay the payable amount via a plurality of third-party payment instruments, wherein the split pay request comprises at least a user selected payment share of the payable amount for each of the plurality of third-party payment instruments. The method thereafter comprises initiating, the payment for the payable amount from each of the plurality of third-party payment instruments based on the split pay request and a payment initiation user input. The method further comprises identifying, a successful or an unsuccessful payment of each user selected payment share of the payable amount. Further the method leads to placing, the order based on the identified successful payment.

### RELATED APPLICATION

This application claims priority under 35 U.S.C. § 119 to Indian Patent Application No. 202141052094, filed on Nov. 13, 2021, the entire contents of which are incorporated herein by reference

### TECHNICAL FIELD

The present invention generally relates to Payment Methodology and more particularly to systems and methods of placing an order on a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

With an advancement in digital technologies, it is now possible for users of electronic devices to place various orders digitally. For instance, a user of an electronic device (say a smartphone) can access a digital platform (say an e-commerce platform) on the electronic device to order one or more items available on said digital platform. In e-shopping once the users decide on what they would like to buy via a specific digital platform, they add the decided item(s) to a cart (i.e., virtual cart present on said specific digital platform) and proceed for checkout. At checkout, they are presented with a gamut of payment instruments to choose from to complete the payment for the item(s). Post choosing a preferred payment instrument, the users are redirected to an appropriate flow to complete the payment. Once payment is processed, the order placement is completed, and the order will be then delivered to the users in a time mentioned.

Currently, the digital platforms generally host third-party payment instruments such as Credit Cards, Debit Cards, Net-banking, Wallets, UPI, Pay Later, EMI and Cash on Delivery (COD) etc. These third-party payment instrument(s) and/or inhouse payment instrument(s) of the digital platforms are provided as part of a payment flow during checkout, where a customer/user can choose a payment instrument to handle transactions. The current payment flow assumes that the customer has the requisite balance on one single digital payment instrument or has enough trust on the digital platforms to pay full amount via prepaid payment modes. Hence, there are a number of limitations of the current payment methods that are provided on digital platforms. In order to overcome some of the limitations of the current payment methods, a number of solutions have been developed over a period of time. Some of the currently known solutions provide the users an option to split a payment to pay split amount via various inhouse payment methods and a third-party payment instrument (such as splitting a payment to pay via a credit card (i.e., a third-party payment instrument) and voucher(s), wallet(s) and/or any currency of a digital platform). These currently known solutions fail to split a bill across multiple third-party payment instruments like Credit Card, Debit Card, UPI and/or third-party Wallet etc. Therefore, currently there is no option to split a payment of a single order across third-party instruments like credit card+UPI, credit card+debit card, credit card+EMI, debit card+EMI, credit card+cod, credit card+credit card etc. Also, the inhouse payment instruments usually have limited reach and a lot of restriction on earn & burn. As currently, for the same transaction, there is no solution to split a payment amount across multiple third-party payment instruments like credit card, debit card, third-party wallet, COD, UPI etc., users need to Top Up an amount to a single payment instrument or transfer the amount to the single payment instrument. Additionally, if a user doesn't want to pay full amount upfront—due to lack of trust, currently there is no option to split a payment to pay some amount via various third-party payment instruments during a transaction and pay the remaining amount at delivery or via a pay later option.

Furthermore, the currently known solutions also have following drawbacks:
1. Convenience: Users have to move from a digital platform on which an order is to be placed to other payment apps to reallocate/top-up one payment instrument that can be used to pay in said digital platform. This can be a tedious process as the users have to login to one or more payment platforms/apps and the users have to transfer and validate the transaction before coming back to the digital platform and pay in the digital platform.
2. Affordability: As credit limit is spread across different credit cards and customers cannot combine them in a single order, they may choose offline stores.
3. Digitization: Customers just entering the digital payments world are apprehensive about the whole process. They do not have the option to split payment across online and offline to build trust on the digital platforms.
4. Lower Prepaid share: Customer choose COD as their credit limit or balance is spread across instruments.
5. Lack of Trust leads to lower orders: If a customer doesn't want to pay full amount upfront—due to lack of trust, he has no option to split pay some amount while ordering & rest amount while delivery.

Therefore, there are a number of limitations of the current solutions and there is a need in the art to provide a method and system of placing an order on a digital platform via a split payment.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system of placing an order on a digital platform via a split payment. Another object of the present invention is to address online payment trust issues by allowing users of the electronic devices to pay an amount of a single order partly via one or more third-party prepaid payment instruments and rest by cash on delivery (CoD)/post order payment option which will build behavior & affinity towards the third-party prepaid payment instruments. Also, an object of the present invention is to improve affordability by allowing customers to use multiple third-party payment instruments for payment of a single order placed on a digital platform. Another object of the present invention is to provide the users a solution that overcomes the limitation of current approach where customers tops-up a payment instrument and then goes for payment. Yet another object of the present invention is to help fringe customers to try prepaid modes.

Furthermore, in order to achieve the aforementioned objectives, the present invention provides a method and system of placing an order on a digital platform.

A first aspect of the present invention relates to the method of placing an order on a digital platform. The method comprises creating, by an order management unit, the order on the digital platform based on a receipt of an order placement request from a user device. The method thereafter encompasses transmitting, by a transceiver unit to the user device, a payable amount based on the created order. Further the method comprises receiving, at the transceiver unit from the user device, a split pay request to pay the payable amount via a plurality of third-party payment instruments, wherein the split pay request comprising: a user selection of the plurality of third-party payment instruments, and a user selected payment share of the payable amount for each of the plurality of third-party payment instruments. The method thereafter comprises initiating, by a payment collection unit, the payment for the payable amount from each of the plurality of third-party payment instruments based on the split pay request and a payment initiation user input. The method further comprises identifying, by the payment collection unit, one of a successful and an unsuccessful payment of each user selected payment share of the payable amount via each corresponding third-party payment instrument from the plurality of third-party payment instruments. Further the method leads to placing, by the order management unit, the order on the digital platform based on the identified successful payment.

Another aspect of the present invention relates to a system of placing an order on a digital platform. The system comprises an order management unit, configured to create, the order on the digital platform based on a receipt of an order placement request from a user device. Also, the system comprises a transceiver unit, configured to transmit to the user device, a payable amount based on the created order. The transceiver unit is also configured to receive from the user device, a split pay request to pay the payable amount via a plurality of third-party payment instruments, wherein the split pay request comprising: a user selection of the plurality of third-party payment instruments, and a user selected payment share of the payable amount for each of the plurality of third-party payment instruments. Also, the system comprises a payment collection unit, configured to initiate, the payment for the payable amount from each of the plurality of third-party payment instruments based on the split pay request and a payment initiation user input. The payment collection unit is also configured to identify, one of a successful and an unsuccessful payment of each user selected payment share of the payable amount via each corresponding third-party payment instrument from the plurality of third-party payment instruments. Further the order management unit is configured to place the order on the digital platform based on the identified successful payment.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for placing an order on a digital platform, in accordance with exemplary embodiments of the present invention.

FIG. 2(a) illustrates exemplary user interfaces for placing an order on a digital platform, in accordance with exemplary embodiments of the present invention.

FIG. 2(b) illustrates exemplary user interfaces for placing an order on a digital platform, in accordance with exemplary embodiments of the present invention.

FIG. 3 illustrates an exemplary method flow diagram [300] for placing an order on a digital platform, in accordance with exemplary embodiments of the present invention.

FIG. 4 illustrates an exemplary flowchart [400] depicting an exemplary process of placing an order on a digital platform, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, an “order management unit” and a “payment collection unit” may be a general-purpose processing unit. Also, as used herein, a “processing unit” or “general-purpose processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, a transceiver unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section, existing technologies have many limitations and in order to overcome at least some of the limitations of the prior known solutions, the present disclosure provides a solution for placing an order on a digital platform. More specifically, the present invention provides a solution that enables a user selection of multiple third-party payment instruments (such as multiple credit cards, credit card+debit etc.) to complete a payment of a single order to place said single order on a digital platform. The present invention also provides the user an option to enter a custom amount for multiple third-party payment instruments to complete a full payment of a single order via said multiple third-party payment instruments. For instance, based on the implementation of features of the present invention, a user can split a bill across multiple third-party payment instruments. An option to split the bill across multiple third-party payment instruments is given to the user and an order will be placed only when payment is successful from all multiple third-party payment instruments (in case CoD or a post order payment instrument is chosen as one of a third-party payment instrument then a payment event will be considered as an interim successful payment event only to place the order), else refund will be processed. In case of refunds & cancellations, refunded amount may be credited either to a source payment instrument as per the split or to inhouse payment instrument(s) of the digital platform, but the same is not limited thereto. The present invention therefore enables on digital platform(s), a mechanism to distribute payment across multiple third-party payment instruments for placing an order.

Therefore, the present invention provides a novel solution of placing an order on a digital platform. The present invention provides a solution that is technically advanced over the currently known solutions as it allows any possible combination of payment instruments. Based on the implementation of features of the present invention even more than 2 third-party payment instruments can be combined for placing an order on a digital platform. Also, the present solution provides a technical advancement over the currently known solutions by providing an option for user selection of a split of amount for each payment instrument available on a digital platform. The present invention also boosts affordability by allowing merging of credit limit & credit and debit payment instruments. Also, the present invention provides technical advancement by providing a solution that allows a split between Postpaid & Prepaid payment methods. The present solution has potential to improve: prepaid share & digitization share; and traffic, orders and GMV of a digital platform. Also, the present solution may improve reach to a new customer base with lower limits/capacity in one payment instrument. Furthermore, the present solution is more convenient compared to current approach where customers first top-up card and then goes for payment. Also, based on the implementation of the features of the present invention, affordability is improved by allowing use of multiple credit limits while placing an order. The present solution also addresses online payment trust issues by allowing customers to pay partly via prepaid payment instruments and rest by postpaid payment instruments, at their own will, which will build behavior & affinity towards prepaid payment instruments.

Hereinafter, exemplary embodiments of the present disclosure will be described in detail with reference to the accompanying drawings so that those skilled in the art can easily carry out the present disclosure.

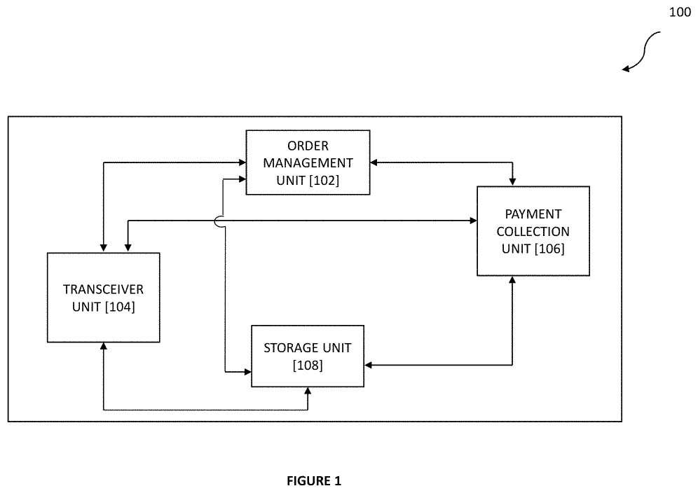

Referring to FIG. 1, an exemplary block diagram of a system [100] for placing an order on a digital platform is shown in accordance with exemplary embodiments of the present disclosure. The system [100] comprises at least one order management unit [102], at least one transceiver unit [104], at least one payment collection unit [106] and at least one storage unit [108]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be present in a server device or connected to the server device to implement the features of the present invention.

The system [100] is configured to place an order on a digital platform with the help of the interconnection between the components/units of the system [100].

The order management unit [102] of the system [100] is connected to the at least one transceiver unit [104], the at least one payment collection unit [106] and the at least one storage unit [108]. The order management unit [102] is configured to create the order on the digital platform based on a receipt of an order placement request from a user device. In a preferred implementation the digital platform is an e-commerce platform, and the order is a single order comprising of one or more items that a user wish to buy via the e-commerce platform. Therefore, in the given preferred implementation, the order management unit [102] is configured to create the single order comprising of the one or more items on the e-commerce platform. In an implementation, the order placement request may be generated based on an indication of a user action of: adding via the user device, product(s) to a shopping cart of the digital platform; and clicking on a continue button on the user device to move forward for payment of the product(s) added to shopping cart, but the same is not limited thereto.

Once the order is created on the digital platform, a payable amount based on the created order is determined by the order management unit [102]. The order management unit [102] provides the determined payable amount to the transceiver unit [104]. Thereafter, the transceiver unit [104] is configured to transmit to the user device, the payable amount determined based on the created order.

Further, in response to the transmitted payable amount, the transceiver unit [104] is configured to receive from the user device, a split pay request to pay the payable amount via a plurality of third-party payment instruments. The split pay request comprises: a user selection of the plurality of third-party payment instruments, and a user selected payment share of the payable amount for each of the plurality of third-party payment instruments. Each third-party payment instrument from the plurality of third-party payment instruments is one of a credit card, a debit card, a cash on delivery, a third-party payment wallet, a unified payments interface (UPI), an EMI, a third party pay later payment instrument, and a net-banking payment instrument, but the same is not limited thereto. Also, each third-party payment instrument from the plurality of third-party payment instruments is one of a pre-stored third-party payment instrument and a new third-party payment instrument. For example, a pre-stored third-party payment instrument may be a credit card, a debit card, a UPI, a third-party wallet etc. that is pre-stored on the digital platform, and a new third-party payment instrument may be a credit card, a debit card, a UPI, a third-party wallet etc. that is not pre-stored on the digital platform and details of the same are added during a payment process to place an order. Further, the user selected payment share of the payable amount for each of the plurality of third-party payment instruments is a payment share assigned to each of the plurality of third-party payment instruments by the user. For example, if a user has selected 3 third-party payment instruments to pay a payable amount say 10,000 INR (i.e., an amount of an order) via the 3 third-party payment instruments, in the given case the user selected payment share of the payable amount (i.e., 10,000 INR) for each of the 3 third-party payment instruments is a payment share assigned to each of the 3 third-party payment instruments by the user (for instance: say 2000 INR for Pt third-party payment instrument, 7000 INR for 2^{nd} third-party payment instrument and 1000 INR for 3^{rd} third-party payment instrument). Therefore, the split pay request comprises the plurality of user selected third-party payment instruments, and the user selected payment share of the payable amount for each of said plurality of third-party payment instruments. Further, the sum of all user selected payment shares of the payable amount is equal to the payable amount. For instance: in the above example the sum of 2000 INR, 7000 INR and 1000 INR is equal to 10,000 INR (i.e., the total payable amount).

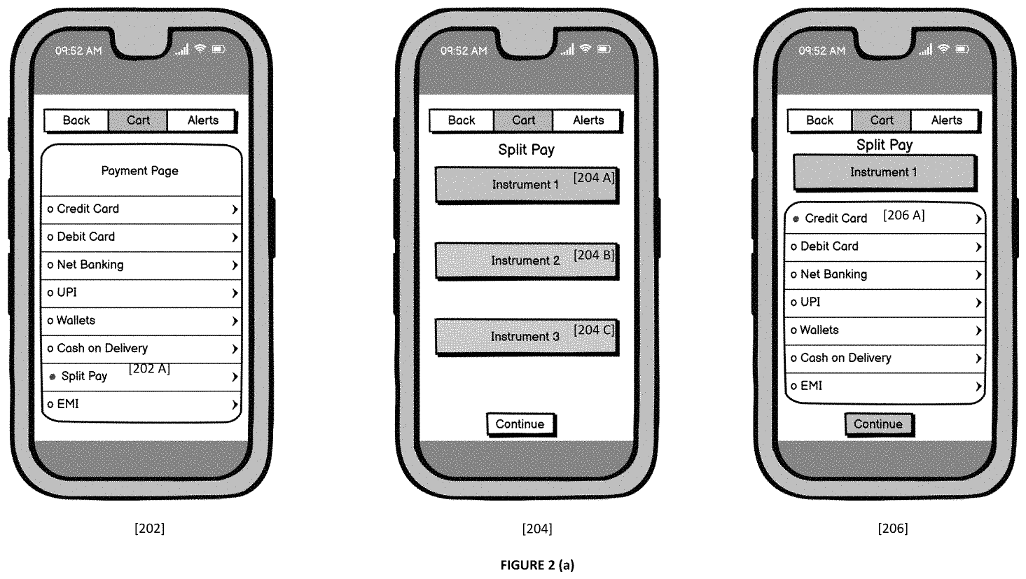

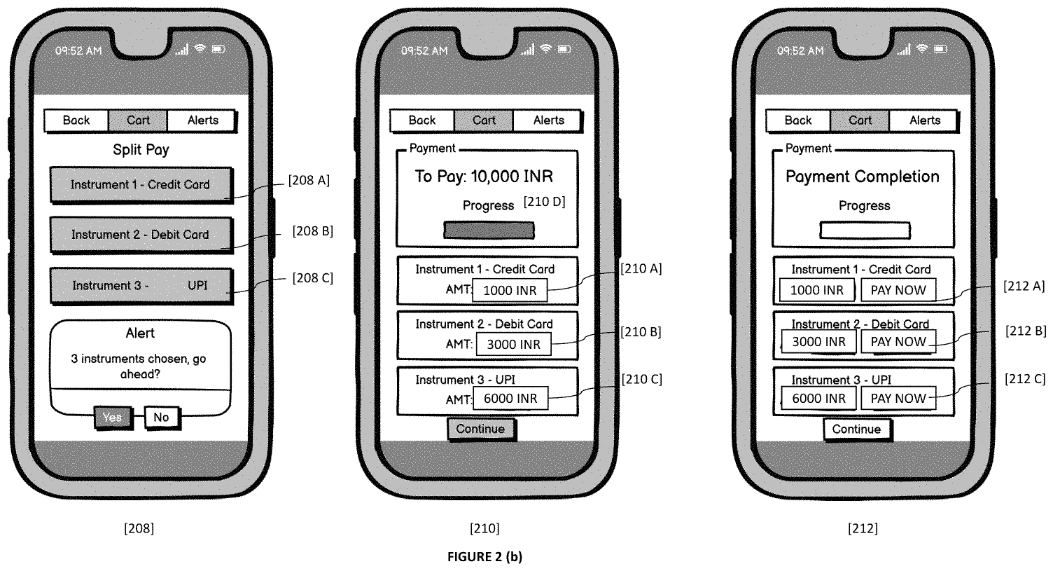

In an implementation, the split pay request may be generated based on an indication of a user selection of a split pay option provided by the digital platform on the user device. Referring to FIG. 2(a) and FIG. 2(b), at FIG. 2(a) exemplary user interfaces for placing an order on a digital platform are shown in accordance with exemplary embodiments of the present invention. FIG. 2(b) also illustrates exemplary user interfaces for placing an order on a digital platform, in accordance with exemplary embodiments of the present invention. More specifically, FIG. 2(a) at [202] depicts an exemplary user interface indicating an exemplary split pay option at [202 A], wherein user selection of such split pay option leads to generation of the split pay request. Also, user interface [204] as shown in the FIG. 2(a) depicts three exemplary options at [204 A], [204 B] and [204 C] to select 3 third-party payment instruments that may be selected by the user to pay a payable amount. Further, if [204 A] is selected by the user, an exemplary user interface as depicted on [206] may be provided to the user to select a third-party payment instrument such as a credit card as shown at [206 A]. Similarly, FIG. 2(b) at [208] depicts an exemplary user interface where at [208 A], [208 B] and [208 C], for three exemplary options, 3 third-party payment instruments are selected by the user to pay the payable amount. Also, user interface [210] as shown in the FIG. 2(b) at [210 A], [210 B] and [210 C] depicts for each of the 3 third-party payment instruments, a user selected payment share (i.e., 1000 INR, 3000 INR, and 6000 INR) of a payable amount (10,000 INR) depicted at [210 D]. Furthermore, based on the exemplary details as indicated in the FIGS. 2(a) and 2(b), a split pay request may comprise a user selection of the 3 third-party payment instruments (i.e., instrument 1, instrument 2 and instrument 3) and a user selected payment share (i.e., 1000 INR, 3000 INR, and 6000 INR, respectively) for each of the 3 third-party payment instruments (i.e., instrument 1, instrument 2 and instrument 3).

Once the split pay request to pay the payable amount via the plurality of third-party payment instruments is received at the transceiver unit [104], an indication of same is provided to the payment collection unit [106] of the system [100]. The payment collection unit [106] is then configured to initiate, the payment for the payable amount from each of the plurality of third-party payment instruments based on the split pay request and a payment initiation user input. The payment initiation user input indicates a user request to initiate a payment. For instance, to provide the payment initiation user input, the user may click on a pay now button provided on a user interface by the digital platform to pay a split amount by one or more third-party payment instruments. The exemplary user interface [212] as shown in FIG. 2(b), at [212 A], [212 B] and [212 C] depicts such pay now buttons. Therefore, once the user selects pay now buttons shown at [212 A], [212 B] and [212 C], a payment initiation user input is provided to the payment collection unit [106] to initiate a payment of 1000 INR, 3000 INR, and 6000 INR, respectively from instrument 1, instrument 2 and instrument 3, in order to further complete a payment of the payable amount (i.e., 10,000 INR).

More particularly, to initiate the payment for the payable amount from each of the plurality of third-party payment instruments, the payment collection unit [106] is configured to identify, one or more third-party payment instruments that are assigned with a corresponding user selected payment share. Thereafter, the payment collection unit [106] is configured to identify from the plurality of third-party payment instruments, one or more third-party payment instruments with an unassigned user selected payment share based on the one or more third-party payment instruments assigned with the corresponding user selected payment share. Each third-party payment instrument from the one or more third-party payment instruments with the unassigned user selected payment share is a third-party payment instrument to which the user has not assigned a payment share to initiate a payment. Therefore, the payment collection unit [106] is configured to identify from the plurality of third-party payment instruments, the one or more third-party payment instruments to which the user has not assigned any payment share, wherein said identification is based on the identification of the one or more third-party payment instruments from the plurality of third-party payment instruments to which the user has already assigned a corresponding payment share. The payment collection unit [106] is then configured to assign, a user selected payment share to each corresponding third-party payment instrument with the unassigned user selected payment share. The payment collection unit [106] is then configured to block for a pre-defined period of time, the user selected payment share for each third-party payment instrument from the plurality of third-party payment instruments assigned with said corresponding user selected payment share. Further, the payment collection unit [106] is configured to initiate, the payment for the payable amount from each of the plurality of third-party payment instruments based on a successful blocking of the user selected payment share of each of the plurality of third-party payment instruments. For example, if a user has selected 3 third-party payment instruments say P1, P2 and P3 to pay a payable amount say 50,000 INR. Also, in the given example the user has assigned P1, a user selected payment share of the payable amount (say 25,000 INR of 50,000 INR), then the payment collection unit [106] in the given example is configured to identify P1 from P1, P2 and P3. Thereafter, in the given example the payment collection unit [106] is configured to identify from P1, P2 and P3 (i.e., the plurality of third-party payment instruments), P2 and P3 (i.e., third-party payment instruments with no corresponding user selected payment share) based on identification of P1 (i.e., identification of the third-party payment instrument assigned with the corresponding user selected payment share). In the given example, the payment collection unit [106] is then configured to assign, a user selected payment share (say 15000 INR and 10000 INR, respectively) to P2 and P3 (i.e., each corresponding third-party payment instrument from the one or more third-party payment instruments with the unassigned user selected payment share).

Further, in the given example, the payment collection unit [106] is configured to bock 25,000 INR, 15,000 INR and 10,000 INR for P1, P2 and P3 respectively. The payment collection unit [106] is thereafter configured to initiate, the payment for 50,000 INR (i.e., the payable amount) from P1, P2 and P3 (i.e., each of the plurality of third-party payment instruments) based on a successful blocking of 25,000 INR, 15,000 INR and 10,000 INR for P1, P2 and P3 respectively (i.e., the user selected payment share of each of the plurality of third-party payment instruments).

Furthermore, in an implementation, in case of unsuccessful blocking of the user selected payment share of one or more of the plurality of third-party payment instruments in the pre-defined period of time, the payment collection unit [106] is also configured to terminate the payment for the payable amount from each of the plurality of third-party payment instruments based on the unsuccessful blocking of the user selected payment share of the one or more of the plurality of third-party payment instruments. For instance: in the above example in case of unsuccessful blocking of at least one of the 25,000 INR, 15,000 INR and 10,000 INR of P1, P2 and P3 respectively in the pre-defined period of time, the payment collection unit [106] is configured to terminate the payment for the 50,000 INR from each of the P1, P2 and P3.

Once, the payment for the payable amount from each of the plurality of third-party payment instruments is initiated by the payment collection unit [106] based on the split pay request and the payment initiation user input, the payment collection unit [106] is then configured to identify, one of a successful and an unsuccessful payment of each user selected payment share of the payable amount via each corresponding third-party payment instrument from the plurality of third-party payment instruments. For instance, in the above example payment collection unit [106] is configured to identify one of a successful and an unsuccessful payment of 25,000 INR, 15,000 INR and 10,000 INR from P1, P2 and P3, respectively.

Thereafter, an information of the one of the identified successful and the identified unsuccessful payment of each user selected payment share of the payable amount via each corresponding third-party payment instrument from the plurality of third-party payment instruments, is provided by the payment collection unit [106] to the order management unit [102]. Thereafter, the order management unit [102] is configured to place the order on the digital platform based on the identified successful payment of each user selected payment share of the payable amount via each corresponding third-party payment instrument from the plurality of third-party payment instruments. Also, in case of an unsuccessful payment of one or more user selected payment share of the payable amount via corresponding one or more third-party payment instruments, the order management unit [102] is also configured to terminate or hold the order placement. In case the order management unit [102] holds the order placement, a fix time period may be provided to the user to re-try the payment for the unsuccessful payment(s). Further, if said payment(s) are successful in the fix time period, the order management unit [102] is configured to place the order, otherwise the order management unit [102] is configured to terminate the order. Also, in case the order placement is terminated and an amount from one or more third-party payment instruments is deducted, then a refund of the same will be processed. For refunds & cancellations, refunded amount may be credited either to a source payment instrument as per the split or to inhouse payment instrument(s) of the digital platform, but the same is not limited thereto. Further, considering the above example the order management unit [102] is configured to place an order based on a successful identification of the payment of 25,000 INR, 15,000 INR and 10,000 INR from P1, P2 and P3, respectively. Also, in case of an unsuccessful identification of the payment of at least one of 25,000 INR, 15,000 INR and 10,000 INR from P1, P2 and P3, respectively, the order management unit [102] is configured to terminate or hold the order placement.

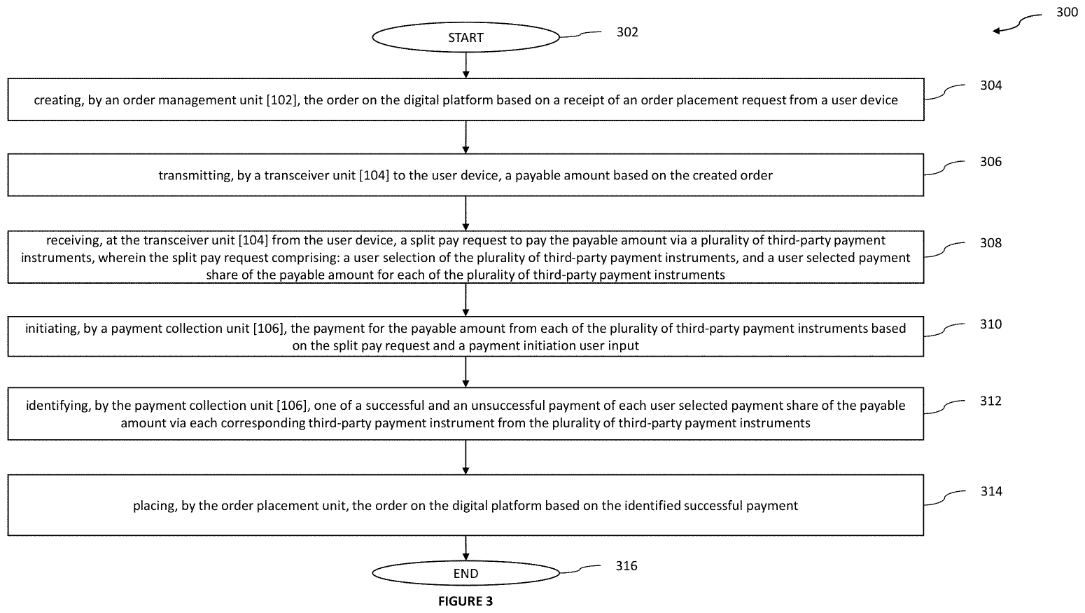

Referring to FIG. 3 an exemplary method flow diagram [300] for placing an order on a digital platform is shown in accordance with exemplary embodiments of the present disclosure. In an implementation the method is performed by the system [100]. Further, in an implementation, the system [100] is connected to or placed within a server unit to implement the features of the present disclosure. Also, as shown in FIG. 3, the method starts at step [302].

Further, at step [304] the method comprises creating, by an order management unit [102], the order on the digital platform based on a receipt of an order placement request from a user device. In a preferred implementation the digital platform is an e-commerce platform, and the order is a single order comprising of one or more items that a user wish to buy via the e-commerce platform. Therefore, in the given preferred implementation, the order management unit [102] creates the single order comprising of the one or more items on the e-commerce platform. In an implementation, the order placement request may be generated based on an indication of a user action of: adding via the user device, product(s) to a shopping cart of the digital platform; and clicking on a continue button on the user device to move forward for payment of the product(s) added to shopping cart, but the same is not limited thereto.

Once the order is created on the digital platform, the method encompasses determining by the order management unit [102], a payable amount based on the created order. Thereafter, the order management unit [102] provides the determined payable amount to a transceiver unit [104]. Next, at step [306] the method comprises transmitting, by the transceiver unit [104] to the user device, the payable amount based on the created order.

Next, at step [308], in response to the transmitted payable amount, the method comprises receiving, at the transceiver unit [104] from the user device, a split pay request to pay the payable amount via a plurality of third-party payment instruments. The split pay request comprises: a user selection of the plurality of third-party payment instruments, and a user selected payment share of the payable amount for each of the plurality of third-party payment instruments. Each of the plurality of third-party payment instrument is one of a credit card, a debit card, a cash on delivery, an EMI, a third party pay later payment instrument, a third-party payment wallet, a unified payments interface (UPI) and a net-banking payment instrument, but the same is not limited thereto. Also, each third-party payment instrument from the plurality of third-party payment instruments is one of a pre-stored third-party payment instrument and a new third-party payment instrument. For example, a pre-stored third-party payment instrument may be a UPI, a third-party pay later payment instrument, an EMI, a third-party wallet etc. that is pre-stored on the digital platform, and a new third-party payment instrument may be a credit card, a debit card, an EMI, a third-party wallet etc. that is not pre-stored on the digital platform and details of the same are added during a payment process to place an order. Further, the user selected payment share of the payable amount for each of the plurality of third-party payment instruments is a payment share assigned to each of the plurality of third-party payment instruments by the user. For example, if a user has selected 4 third-party payment instruments to pay a payable amount say 12,000 INR (i.e., an amount of an order), in the given case the user selected payment share of the payable amount (i.e., 12,000 INR) for each of the 4 third-party payment instruments is a payment share assigned to each of the 4 third-party payment instruments by the user (for instance: say 2000 INR for Pt third-party payment instrument, 5000 INR for 2^{nd} third-party payment instrument, 1000 INR for 3^{rd} third-party payment instrument and 4000 INR for 4^{th} third-party payment instrument). Therefore, the split pay request comprises the plurality of user selected third-party payment instruments, and the user selected payment share of the payable amount for each of said plurality of third-party payment instruments. Also, in an implementation the method encompasses generating the split pay request based on an indication of a user selection of a split pay option provided by the digital platform on the user device. Further, the sum of all user selected payment shares of the payable amount is equal to the payable amount. For instance: in the above example the sum of 2000 INR, 5000 INR, 1000 INR and 4000 INR is equal to 12,000 INR (i.e., the total payable amount). Also, in case if there are n third-party payment instruments selected by the user to pay a payable amount and the user has provided a payment share of n−1 third-party payment instruments out of the n third-party payment instruments. The method in such case also encompasses automatically determining a payment share for the n^{th} third-party payment instrument from the payable amount by a payment collection unit [106], based on the user provided payment share of n−1 third-party payment instruments and the total payable amount.

Once the split pay request to pay the payable amount via the plurality of third-party payment instruments is received at the transceiver unit [104], an indication of same is provided to the payment collection unit [106]. Next, at step [310] the method comprises initiating, by the payment collection unit [106], the payment for the payable amount from each of the plurality of third-party payment instruments based on the split pay request and a payment initiation user input. The payment initiation user input indicates a user request to initiate a payment. For instance, to provide the payment initiation user input, the user may click on a pay now button that is provided on a user interface of the user device by the digital payment to pay a split amount by one or more third-party payment instruments.

Furthermore, the process of initiating, by the payment collection unit [106], the payment for the payable amount from each of the plurality of third-party payment instruments also comprises identifying, by the payment collection unit [106] from the plurality of third-party payment instruments, one or more third-party payment instruments that are assigned with a corresponding user selected payment share. For example, if a user has selected 3 third-party payment instruments say PI1, PI2 and PI3 to pay a payable amount say 8,000 INR. Also, in the given example the user has assigned PI1, a user selected payment share of the payable amount (say 5,000 INR of 8,000 INR), then the method/process via the payment collection unit [106] in the given example encompasses identifying from PI1, PI2 and PI3 (i.e., from the plurality of third-party payment instruments), PI1 (i.e., the third-party payment instruments that is assigned with a corresponding user selected payment share i.e., the 5,000 INR). Thereafter, said process leads to identifying by the payment collection unit [106] from the plurality of third-party payment instruments, one or more third-party payment instruments with an unassigned user selected payment share based on the one or more third-party payment instruments assigned with the corresponding user selected payment share. Each third-party payment instrument from the one or more third-party payment instruments with the unassigned user selected payment share is a third-party payment instrument to which the user has not assigned a payment share to initiate a payment. Therefore, the payment collection unit [106] identifies from the plurality of third-party payment instruments, the one or more third-party payment instruments to which the user has not assigned any payment share, wherein said identification is based on the identification of the one or more third-party payment instruments from the plurality of third-party payment instruments to which the user has already assigned a corresponding payment share. For instance, in the above example, the process further comprises identifying by the payment collection unit [106], from PI1, PI2 and PI3 (i.e., the plurality of third-party payment instruments), PI2 and PI3 (i.e., third-party payment instruments with an unassigned user selected payment share) based on P1 (i.e., the third-party payment instrument assigned with the corresponding user selected payment share). Further, said process encompasses assigning, by the payment collection unit [106], a user selected payment share to each corresponding third-party payment instrument from the one or more third-party payment instruments with the unassigned user selected payment share. For instance: in the above example, the method comprises assigning by the payment collection unit [106], a user selected payment share (say 2000 INR and 1000 INR, respectively) to PI2 and PI3 (i.e., each corresponding third-party payment instrument from the one or more third-party payment instruments with the unassigned user selected payment share). Thereafter said process encompasses blocking for a pre-defined period of time, by the payment collection unit [106], the user selected payment share for each third-party payment instrument from the plurality of third-party payment instruments assigned with said corresponding user selected payment share. Further, said process leads to initiating, by the payment collection unit [106], the payment for the payable amount from each of the plurality of third-party payment instruments based on a successful blocking of the user selected payment share of each of the plurality of third-party payment instruments. Considering the above example, the method further comprises initiating by the payment collection unit [106], the payment for 8,000 INR (i.e., the payable amount) from PI1, PI2 and PI3 (i.e., each of the plurality of third-party payment instruments) based on a successful blocking of 5,000 INR, 2,000 INR and 1,000 INR to PI1, PI2 and PI3, respectively (i.e., the user selected payment share of each of the plurality of third-party payment instruments).

Furthermore, in an implementation, in case of unsuccessful blocking of the user selected payment share of one or more of the plurality of third-party payment instruments in the pre-defined period of time, the method also comprises terminating, by the payment collection unit [106], the payment for the payable amount from each of the plurality of third-party payment instruments based on the unsuccessful blocking of the user selected payment share of the one or more of the plurality of third-party payment instruments. For instance: in the above example in case of unsuccessful blocking of at least one of the 5,000 INR, 2,000 INR and 1,000 INR of PI1, PI2 and PI3 respectively, the method encompasses terminating by the payment collection unit [106], the payment for the 8,000 INR from each of the PI1, PI2 and PI3.

Once, the payment for the payable amount from each of the plurality of third-party payment instruments is initiated by the payment collection unit [106] based on the split pay request and the payment initiation user input, next, at step [312] the method comprises identifying, by the payment collection unit [106], one of a successful and an unsuccessful payment of each user selected payment share of the payable amount via each corresponding third-party payment instrument from the plurality of third-party payment instruments.

For instance, in the above example the method via the payment collection unit [106] identifies, one of a successful and an unsuccessful payment of 5,000 INR, 2,000 INR and 1,000 INR from PI1, PI2 and PI3, respectively.

Thereafter, an information of the one of the identified successful and the identified unsuccessful payment of each user selected payment share of the payable amount via each corresponding third-party payment instrument from the plurality of third-party payment instruments, is provided by the payment collection unit [106] to the order management unit [102]. Next, at step [314] the method comprises placing, by the order management unit [102], the order on the digital platform based on the identified successful payment of each user selected payment share of the payable amount via each corresponding third-party payment instrument from the plurality of third-party payment instruments. Also, in case of an unsuccessful payment of one or more user selected payment share of the payable amount via corresponding one or more third-party payment instruments, the method encompasses terminating or holding by the order management unit [102], the order placement. In case the order management unit [102] holds the order placement, a fix time period may be provided to the user to re-try the payment for the unsuccessful payment(s). Further, if said payment(s) are successful in the fix time period, the order management unit [102] is leads to placing the order, otherwise the order management unit [102] terminates the order. Also, in case the order placement is terminated and an amount from one or more third-party payment instruments is deducted, then a refund of the same will be processed. For refunds & cancellations, refunded amount may be credited either to a source payment instrument as per the split or to inhouse payment instrument(s) of the digital platform, but the same is not limited thereto. Further, considering the above example the method encompasses placing by the order management unit [102], an order based on a successful identification of the payment of 5,000 INR, 2,000 INR and 1,000 INR from PI1, PI2 and PI3, respectively. Also, in case of an unsuccessful identification of the payment of at least one of 5,000 INR, 2,000 INR and 1,000 INR from PI1, PI2 and PI3, respectively, the order management unit [102] terminates or holds the order placement.

Further, after placing the order on the digital platform, the method terminates at step [316].

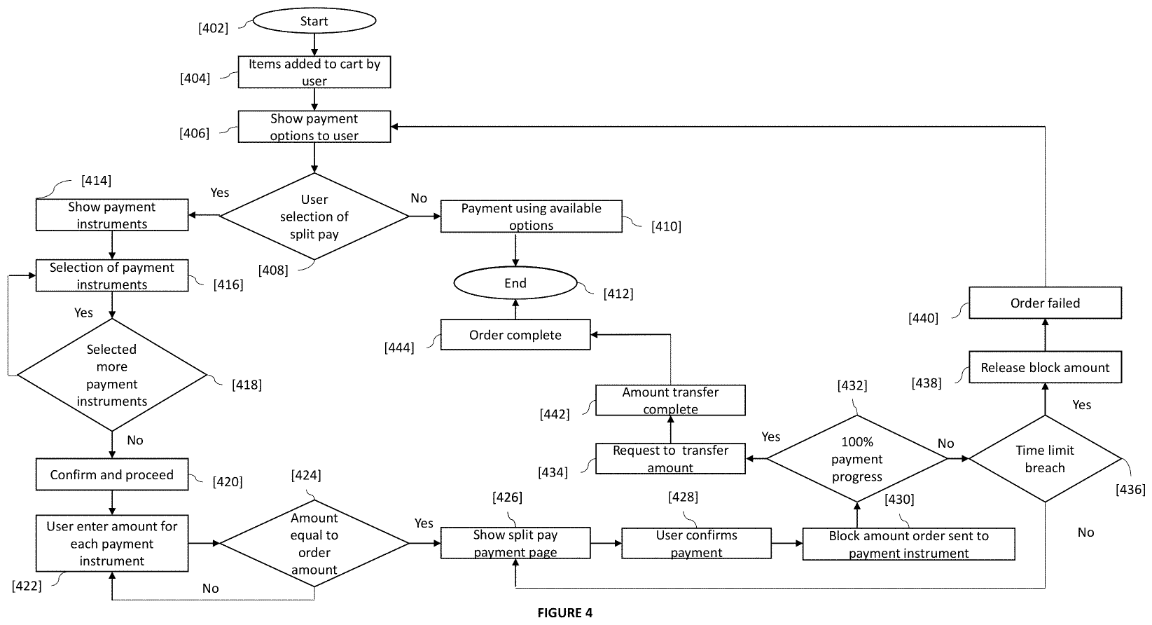

Referring to FIG. 4 an exemplary flowchart [400] depicting an exemplary process of placing an order on a digital platform is shown in accordance with exemplary embodiments of the present invention. As shown in FIG. 4, the method starts at step [402].

Thereafter, at step [404] the method encompasses receiving at a system [100] (the system [100] is configured at a server unit of a digital platform) from a user device an indication of addition of one or more items in a shopping cart of the digital platform. For example, at step [404], a user browses and chooses products available on an e-commerce inventory using an e-commerce service application (ESA) installed on a user device. To add product(s) in a shopping cart of an e-commerce platform, the e-commerce service application (ESA) interacts directly with the system [100] configured at an e-commerce server (ES) which has its own storage unit [108].

Next, at step [406], the method encompasses displaying by the system [100], one or more payment options at a user interface of the user device. For instance, in the above example, post adding products to the shopping cart and clicking on a continue button to move forward for payment, an order is created by an order management unit [102] and then the order management unit [102] extracts a payment product related information of the user from a User Information Database stored at the storage unit [108]. The order management unit [102], displays the payment product related information on a payment options page of the ESA for the user to select.

Next, at step [408], the method comprises identifying if a user selection of a split pay option is received at the system [100] to initiate a payment of the created order via multiple third-party payment instruments. In case, the user selection of the split pay option is received at the system [100], the method leads to step [414]. Otherwise, the method leads to step [410], where at step [410] a payment is done using the general/available payment options to place the created order. From step [410], the method leads to step [412] and the method then terminates at step [412].

Further, at step [414], the method comprises displaying various third-party payment instruments at the user interface of the user device by the system [100]. Thereafter, at step [416] a user selection of two or more third-party payment instruments is received to pay a payment amount of the order to be placed. Next at step [418] it is identified if additional third-party payment instrument(s) are also selected by the user, in case the additional third-party payment instrument(s) are selected by the user the method will lead to step [416]. Otherwise, the method proceeds to step [420]. Further, at step [420], the selection of third-party payment instruments is confirmed, and the method proceeds to step [422]. For instance, in the above example, when the user opts for ‘Split Pay’ in the payment options page and clicks on continue, the system [106] of the ES serves the ESA, the split pay page with multiple third-party payment instruments to be selected. The ES updates the order management unit (OMU) [102] regarding split pay option selection, post which an event is created by the Payment collection unit (PCU) [106] of the system. The PCU [106] creates an entry in a payment information database (PCD) (stored at the storage unit [108]) to track a progress of payment completion. At the split pay instruments page sent to the ESA by ES, the user must click on two or more third-party payment instrument options to go to a next page and choose the third-party payment instruments to pay through. Further, the details of user selected third-party payment instruments are communicated to the payment collection unit [106] through OMU [102]. The PCU [106] updates the payment information database (at the storage unit [108]) with an information of the third-party payment instruments chosen by the user. Also, post selection of the third-party payment instruments by the user, the user needs to click on a continue option to go ahead with payment. In an event, the system [100] alerts the user to confirm number of third-party payment instruments chosen.

Further, at step [422], the method encompasses receiving a user defined share of a total amount of the created order, for each of the user selected third-party payment instruments. Next, at step [424], the method encompasses identifying if a total of all user defined shares for all of the corresponding user selected third-party payment instruments is equal to the total amount of the created order. In case, the total of all user defined shares for all of the corresponding user selected third-party payment instruments is equal to the total amount of the created order, the method leads to step [426]. Otherwise, the method leads to step [422]. Further, at step [426], a split pay payment page is displayed at the user interface of the user device by the system [100], wherein the split pay payment page shows an option for confirmation of the user defined shares of the total amount of the created order for all user selected third-party payment instruments. The method further at step [428] encompasses conforming by the user, the user defined shares of the total amount of the created order for all user selected third-party payment instruments. Thereafter, at step [430], the user defined shares of the total amount of the created order for all user selected third-party payment instruments are blocked and thereafter at step [432] the method identifies if a 100% payment progress is achieved. If 100% payment progress is achieved the method leads to step [434], otherwise the method leads to step [436]. Considering the above example, post confirmation of the third-party payment instruments chosen, the users are presented with a page to enter desired amount on each third-party payment instrument by the system [100]. This page cannot be continued further till 100% of order amount is distributed among the chosen third-party payment instruments by the user. Post confirming amounts on the third-party payment instruments, the users click a continue option to proceed further onto split pay payments page presented by the system [100] where the user has to individually pay the respective amount of each third-party payment instrument. A progress bar is presented on the user interface of the user device to show payment completion. When the user proceeds to complete payment on each third-party payment instrument, the OMU [102] via a payment signaling system (PSS) sends block amount order to the respective third-party payment instrument. Post successful block order acknowledgement, PSS updates PCU [106] on transaction status through OMU [102]. Also, the PCU [106] updates a payment information database and a payment completion database (at the storage unit [108]) on the transaction status (119) and updates on progress completed. This process is repeated ‘n’ times, n being number of third-party payment instruments chosen by user. The PCU [106] checks with payment completion database on 100% progress achievement, post which it updates the OMU [102]. The OMU [102] signals the PSS on 100% completion post which, the PSS sends request to release amount to all the third-party payment instruments to complete the order and updates PCU [106] on status.

Further, at step [436], it is identified if a pre-defined time limit is over, if the pre-defined time limit is over the method leads to step [438]. Otherwise, the method leads to step [426]. Further at step [438] the blocked user defined shares of the total amount of the created order for all user selected third-party payment instruments are released and the method leads to [440]. Further, at step [440], the order placement is failed and the method then leads to step [406].

Also, at step [434], a request to transfer the user defined shares of the total amount of the created order from all corresponding user selected third-party payment instruments is initiated and the method leads to [442] from [434]. Further, at step [442] the amount transfer is completed and then at step [444] the order is successfully placed. From the step [444], the method leads to step [412] and the method terminates at [412]. Considering the above example, the PCU [106] updated the OMU [102] on payment receipt which successfully executes the order. The OMU [102] via the transceiver unit [104] displays successful order completion on the EAS. Also, block orders sent by PSS may be valid for 2 hrs since order sent to a first third-party payment instrument. All the third-party payment instruments with successful block orders remains intact and the user doesn't have to re-do it. If block orders are not sent to all the third-party payment instruments in the timeframe, the PCU [106] updates the payment transaction as a failure and update the OMU [102] regarding it. The PCU [106] interacts with the PSS to release block orders on all other third-party payment instruments in the transaction.

After, placing the order on the digital platform, the method terminates at [412].

Furthermore, there are a number of use cases of the present invention, and few use cases are provided as below:
1. Users of digital platforms can choose to pay a share of a total amount while placing an order & rest at delivery. This will also enable the users to split payment between Prepaid & Prepaid which will help in developing trust on online payments for new digitized customers.
2. Users can combine credit & debit instruments, in case of lack of liquidity/credit limit.
3. Users can merge credit limit from multiple credit instruments thus improving overall affordability.

The present solution also has a potential to impact business at multiple places. A few of the important factors are:
Engagement and increased revenue: The present invention may boost traffic to a digital platform as customers will have access to higher purchase power and can buy higher priced products by combining credit instruments.
Affordability: Customer can better manage their affordability needs by splitting the bill across Credit & EMI/EMI & Debit etc. payment instruments.
Digitization: Potential to uplift the prepaid share as customer is allowed to pay partly via prepaid mode & rest by post-paid while delivery.
Customer Experience: Convenience will improve payment experience of the customer which will increase a digital platform's experience.
New customers: Will improve reach to a new customer base with lower limits/capacity in one payment instrument.

Thus, the present invention provides a novel solution of placing an order on a digital platform. The present invention provides a solution that is technically advanced over the currently known solutions as it allows any possible combination of payment instruments. Based on the implementation of features of the present invention even more than 2 third-party payment instruments can be combined for placing an order on a digital platform. Also, the present solution provides a technical advancement over the currently known solutions by providing an option for user selection of a split of amount for each payment instrument available on a digital platform. The present invention also boosts affordability by allowing merging of credit limit & credit and debit payment instruments. Also, the present invention provides technical advancement by providing a solution that allows a split between Postpaid & Prepaid payment methods. The present solution has potential to improve: prepaid share & digitization share; and traffic, orders and GMV of a digital platform. Also, the present solution may improve reach to a new customer base with lower limits/capacity in one payment instrument. Furthermore, the present solution is more convenient compared to current approach where customers first top-up card and then goes for payment. Also, based on the implementation of the features of the present invention, affordability is improved by allowing use of multiple credit limits while placing an order. The present solution also addresses online payment trust issues by allowing customers to pay partly via prepaid payment instruments and rest by postpaid payment instruments, at their own will, which will build behavior & affinity towards prepaid payment instruments. Furthermore, the present solution provides a sequential payment process for payment instruments selected and the progress of amount paid can be tracked through present solution.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

We claim:

1. A method of placing an order on a digital platform, the method comprising:
creating, by an order management unit [102], the order on the digital platform based on a receipt of an order placement request from a user device;
transmitting, by a transceiver unit [104] to the user device, a payable amount based on the created order;
receiving, at the transceiver unit [104] from the user device, a split pay request to pay the payable amount via a plurality of third-party payment instruments, wherein the split pay request comprising:
a user selection of the plurality of third-party payment instruments, and
a user selected payment share of the payable amount for each of the plurality of third-party payment instruments;
initiating, by a payment collection unit [106], the payment for the payable amount from each of the plurality of third-party payment instruments based on the split pay request and a payment initiation user input;
identifying, by the payment collection unit [106], one of a successful and an unsuccessful payment of each user selected payment share of the payable amount via each corresponding third-party payment instrument from the plurality of third-party payment instruments; and
placing, by the order management unit [102], the order on the digital platform based on the identified successful payment.

2. The method as claimed in claim 1, wherein each of the plurality of third-party payment instrument is one of a credit card, a debit card, a cash on delivery, a third-party payment wallet, a unified payments interface (UPI), an EMI, a third party pay later payment instrument and a net-banking payment instrument.

3. The method as claimed in claim 1, wherein each third-party payment instrument from the plurality of third-party payment instruments is one of a pre-stored third-party payment instrument and a new third-party payment instrument.

4. The method as claimed in claim 1, wherein a sum of all user selected payment shares of the payable amount is equal to the payable amount.

5. The method as claimed in claim 1, wherein initiating, by a payment collection unit, the payment for the payable amount from each of the plurality of third-party payment instruments further comprises:
identifying, by the payment collection unit [106] from the plurality of third-party payment instruments, one or more third-party payment instruments that are assigned with a corresponding user selected payment share,
identifying, by the payment collection unit [106] from the plurality of third-party payment instruments, one or more third-party payment instruments with an unassigned user selected payment share based on the one or more third-party payment instruments assigned with the corresponding user selected payment share,
assigning, by the payment collection unit [106], a user selected payment share to each corresponding third-party payment instrument from the one or more third-party payment instruments with the unassigned user selected payment share,
blocking for a pre-defined period of time, by the payment collection unit [106], the user selected payment share for each third-party payment instrument from the plurality of third-party payment instruments assigned with said corresponding user selected payment share, and
initiating, by the payment collection unit [106], the payment for the payable amount from each of the plurality of third-party payment instruments based on a successful blocking of the user selected payment share of each of the plurality of third-party payment instruments.

6. The method as claimed in claim 5, the method further comprises terminating, by the payment collection unit [106], the payment for the payable amount from each of the plurality of third-party payment instruments based on an unsuccessful blocking of the user selected payment share of one or more of the plurality of third-party payment instruments.

7. A system of placing an order on a digital platform, the system comprising:
an order management unit [102], configured to create, the order on the digital platform based on a receipt of an order placement request from a user device;
a transceiver unit [104], configured to:
transmit to the user device, a payable amount based on the created order, and
receive from the user device, a split pay request to pay the payable amount via a plurality of third-party payment instruments, wherein the split pay request comprising:
a user selection of the plurality of third-party payment instruments, and
a user selected payment share of the payable amount for each of the plurality of third-party payment instruments; and
a payment collection unit [106], configured to:
initiate, the payment for the payable amount from each of the plurality of third-party payment instruments based on the split pay request and a payment initiation user input, and
identify, one of a successful and an unsuccessful payment of each user selected payment share of the payable amount via each corresponding third-party payment instrument from the plurality of third-party payment instruments, wherein:
the order management unit [102] is further configured to place the order on the digital platform based on the identified successful payment.

8. The system as claimed in claim 7, wherein each of the plurality of third-party payment instrument is one of a credit card, an EMI, a third party pay later payment instrument, a debit card, a cash on delivery, a third-party payment wallet, a unified payments interface (UPI) and a net-banking payment instrument.

9. The system as claimed in claim 7, wherein each third-party payment instrument from the plurality of third-party payment instruments is one of a pre-stored third-party payment instrument and a new third-party payment instrument.

10. The system as claimed in claim 7, wherein a sum of all user selected payment shares of the payable amount is equal to the payable amount.

11. The system as claimed in claim 7, wherein to initiate the payment for the payable amount from each of the plurality of third-party payment instruments, the payment collection unit [106] is further configured to:
identify from the plurality of third-party payment instruments, one or more third-party payment instruments that are assigned with a corresponding user selected payment share,
identify from the plurality of third-party payment instruments, one or more third-party payment instruments with an unassigned user selected payment share based on the one or more third-party payment instruments assigned with the corresponding user selected payment share;
assign, a user selected payment share to each corresponding third-party payment instrument from the one or more third-party payment instruments with the unassigned user selected payment share,
block for a pre-defined period of time, the user selected payment share for each third-party payment instrument from the plurality of third-party payment instruments assigned with said corresponding user selected payment share, and
initiate, the payment for the payable amount from each of the plurality of third-party payment instruments based on a successful blocking of the user selected payment share of each of the plurality of third-party payment instruments.

12. The system as claimed in claim 11, wherein the payment collection unit [106] is further configured to terminate the payment for the payable amount from each of the plurality of third-party payment instruments based on an unsuccessful blocking of the user selected payment share of one or more of the plurality of third-party payment instruments.
